(19) United States
(12) Patent Application Publication
(10) Pub. No.: US 2022/0397290 A1
(43) Pub. Date: Dec. 15, 2022

(54) HYBRID CLEAN ROOM SYSTEM AND MANUFACTURING METHOD THEREFOR

(71) Applicant: DASAN PANEL & GLOBE CO., LTD., Paju-si, Gyeonggi-do (KR)

(72) Inventor: Hankyul JUNG, Namyangju-si, Gyeonggi-do (KR)

(73) Assignee: DASAN PANEL & GLOBE CO., LTD., Paju-si, Gyeonggi-do (KR)

(21) Appl. No.: 17/777,063

(22) PCT Filed: Nov. 16, 2020
(86) PCT No.: PCT/KR2020/016050

§ 371 Date: May 16, 2022

(30) Foreign Application Priority Data
Nov. 18, 2019 (KR) 10-2019-0147585

(51) Int. Cl. F24F 3/167; F24F 11/52; F24F 13/10; F24F 11/74; F24F 8/108; B08B 5/02

(52) U.S. Cl. CPC F24F 3/167; F24F 11/52; F24F 13/10; F24F 11/74; F24F 8/108; B08B 5/02; F24F 2110/64

(57) ABSTRACT

A hybrid clean room system includes: a clean room which includes a plurality of side walls arranged in the vertical direction between a floor part and a ceiling part; a circulation part which is disposed outside of the clean room, and which forms a closed space along the upper plate with the other two facing side walls from among the plurality of side walls; an air pump disposed in the circulation part; a plurality of discharge ports, which are arranged on the other two facing side walls from among the plurality of side walls so as to supply, to the clean room, the air that is discharged from the air pump and passes through the circulation part; a suction part disposed at at least one of the plurality of side walls, and connected to the air pump.

### TECHNICAL FIELD

The present invention relates to a hybrid clean room system and a manufacturing method therefor, and more particularly, to a hybrid clean room system and a manufacturing method therefor, which allows a clean room to be manufactured on entrances and exits of buildings or structures in the private sector such as residence, business, education, leisure, etc., and is capable of separating and collecting dust, pollutants, fine dust or the like from a visitor through an air shower when the visitor enters the clean room, preventing the growth of mold and bacteria, removing and filtering odors, and circulating air in the clean room.

### BACKGROUND ART

In general, a dust collector is a device that collects various kinds of dust or dirt generated by various work activities in one place to clearly treat the same for prevention of environmental pollution, maintenance of cleanliness of a work space, improvement of a work environment, health of workers and the like. As for the dust collector, there are various devices such as a device using a filter or a filter net, a device using gravity or inertial force, a device using an electrical property or an adsorptive force of water, oil or the like, etc.

The dust collector is provided with a suction port to collect dust, trash or the like, and transfers the collected dust or trash to a central dust collection facility for batch processing, thereby keeping an internal space of a structure clean.

The dust collector described above is mainly used in industrial fields of manufacturing semiconductors, electronic parts, precision instruments, etc., or is also used in fields requiring a high degree of dust prevention function, such as production facilities, examination rooms and laboratories in a food or pharmaceutical industry, etc., medical facilities in hospitals, and the like.

However, most of the above-described dust collectors are not applied to facilities in the private sector, such as common houses, general homes or the like. Thus, when entering a room from outside, various kinds of dust, foreign substances or the like from the outside enter together while adhering to people's clothes or skin, thus causing respiratory system diseases, dermatitis or the like of indoor residents.

In particular, in recent years, a concentration of fine dust harmful to the human body has increased in the atmosphere, thus causing a social problem. In particular, PM10 (particulate matter with a diameter less than 10 μm), which is respiratory dust or fine dust with a particle diameter of 10 μm or less, has a long stay in the atmosphere and is deposited in the lungs of humans, thereby causing various diseases related to heart disease and lung cancer. When the fine dust in the air is attached to people's clothes, etc. and flows into an indoor area with a relatively less air circulation than outdoors, there is a problem of increasing the probability of entering the body of people indoors through breathing.

### DISCLOSURE

### Technical Problem

To solve the problems described above, an object of the present invention is to provide a hybrid clean room system and a manufacturing method therefor, which allows a clean room to be manufactured on entrances and exits in the private sector such as residence, business, education, leisure, etc., and is capable of separating and collecting dust, pollutants, fine dust or the like from a visitor through an air shower when the visitor enters the clean room, inhibiting the growth of mold and bacteria, removing and filtering odors, and circulating air in the clean room.

### Technical Solution

To achieve the object described above, a hybrid clean room system according to an embodiment of the present invention may include: a clean room which includes a plurality of side walls arranged in the vertical direction between a floor part and a ceiling part, which face each other, and an upper plate positioned on the plurality of side walls, and which includes doors arranged on two facing side walls from among the plurality of side walls; a circulation part which is disposed outside of the clean room, and which forms a closed space along the upper plate with the other two facing side walls from among the plurality of side walls; an air pump disposed in the circulation part so as to discharge air; a plurality of air outlets, which are arranged on the other two facing side walls from among the plurality of side walls so as to supply, to the clean room, the air that is discharged from the air pump and passes through the circulation part; a suction part disposed on at least one of the plurality of side walls, and connected to the air pump so as to suction the air from the clean room; and a filtering part disposed between the suction part and the air pump so as to filter out dust or pollutants from the air suctioned through the suction part.

In addition, the hybrid clean room system may further include a first sensor part disposed in the clean room so as to detect a visitor and a body size thereof in the clean room, and a control part for controlling an operation of the air pump and the suction part based on the sensing information of the first sensor part.

Furthermore, the hybrid clean room system may further include an opening/closing adjustment part for adjusting opening and closing of a plurality of air outlets, and the control part may open and close the plurality of air outlets through the opening/closing adjustment part according to a body size of a visitor detected through the first sensor part.

Moreover, the control part may further include a shower controller disposed in the clean room so as to control whether or not air is discharged in the clean room, the intensity of the air, and the opening/closing adjustment part.

Besides, the suction part may include a suction port having a plurality of holes; and a communication part for connecting the suction port and the air pump.

The hybrid clean room system according to the present invention may further include a lighting part providing lighting to the clean room. Thus, a bright environment may be provided to the clean room by the light provided from the lighting part.

The filtering part may include metal nanoparticles having a function of fighting bacteria and sterilizing the filtered air, emitting far-infrared rays to the filtered air, or emitting minerals.

Metal nanoparticles may be at least one selected from the group consisting of silicon (Si), copper (Cu), zinc (Zn), brass, aluminum (Al), beryllium (Be), magnesium (Mg), germanium (Ge), strontium (Sr), barium (Ba), yttrium (Y), titanium (Ti), zirconium (Zr), hafnium (Hf), vanadium (V), niobium (Nb), tantalum (Ta), lanthanum (La), silver (Ag), gold (Au), platinum (Pt), palladium (Pd), and oxides thereof.

In addition, the clean room may be provided with a dust measuring sensor for measuring a concentration of dust contained in the air, and the one side wall may be equipped with a first light which turns on when the concentration of dust measured by the dust measuring sensor is measured to be a preset reference or above, and a second light sensor which turns on when the concentration of dust is less than the preset reference.

Meanwhile, to achieve the objects described above, a method for manufacturing a hybrid clean room according to an embodiment of the present invention may include: (a) forming a clean room which includes a plurality of side walls arranged in the vertical direction between a floor part and a ceiling part, which face each other, and an upper plate positioned on the plurality of side walls, and which includes doors arranged on two facing side walls from among the plurality of side walls; (b) forming a circulation part which is disposed outside of the clean room, and which forms a closed space along the upper plate with the other two facing side walls from among the plurality of side walls; (c) arranging a plurality of air outlets on two facing side walls from among the plurality of side walls; (d) disposing an air pump in the circulation part; (e) disposing a suction part connected to the air pump on at least one of the plurality of side walls; and (f) disposing a filtering part for filtering the discharged air from the air pump.

In addition, (a) may include disposing in the clean room a first sensor part for detecting a visitor and a body size thereof in the clean room.

Furthermore, (b) may include disposing in the circulation part a control part for controlling an operation of the air pump and the suction part based on the sensing information of the first sensor part.

Moreover, (c) may include disposing an opening/closing adjustment part for adjusting opening and closing of a plurality of air outlets on at least one of the plurality of side walls.

Besides, the control part may open and close the plurality of air outlets through the opening/closing adjustment part according to a body size of a visitor detected through the first sensor part.

And, the method may further include disposing a shower controller in the clean room so as to control whether or not air is discharged in the clean room, the intensity of the air, and the opening/closing adjustment part.

### Advantageous Effects

According to the present invention, provided are a hybrid clean room system and a manufacturing method therefor, which allows a clean room to be manufactured on entrances and exits in the private sector such as residence, business, education, leisure, etc., and is capable of separating and collecting dust, pollutants, fine dust or the like from a visitor through an air shower when the visitor enters the clean room, inhibiting the growth of mold and bacteria, removing and filtering odors, and circulating air in the clean room.

### DESCRIPTION OF DRAWINGS

FIG. 1 is a sectional view schematically showing an overall configuration of a hybrid clean room system according to an embodiment of the present invention.

FIG. 2 is a view showing an example in which a plurality of air outlets and doors are arranged on a wall surface of a clean room according to an embodiment of the present invention.

FIG. 3 is a view showing a second wall surface of a clean room according to an embodiment of the present invention.

FIG. 4 is a view showing a fourth wall surface of a clean room according to an embodiment of the present invention.

FIG. 5 is a view showing one example of a first sensor part disposed in a clean room according to an embodiment of the present invention.

FIG. 6 is a view showing an entrance door disposed in a clean room according to another embodiment of the present invention.

FIG. 7 is a view showing a lighting part providing lighting to a clean room according to an embodiment of the present invention.

FIG. 8 is a view showing an air pump for discharging air to a clean room according to an embodiment of the present invention.

FIG. 9 is a view showing a flow chart of operations for explaining a method for manufacturing a hybrid clean room according to an embodiment of the present invention.

### MODE FOR INVENTION

Advantages and features of the present invention and methods of achieving the same will become apparent with reference to the embodiments described below in detail along with the accompanying drawings. However, the present invention is not limited to the embodiments disclosed below, but will be implemented in a variety of different forms, and these embodiments are provided only for making the disclosure of the present invention complete and notifying the scope of the invention to those skilled in the art to which the present invention pertains and the present invention is only defined by the scope of the claims. Accordingly, in some embodiments, well-known process steps, well-known element structures, and well-known techniques are not specifically described in order to avoid obscuring the present invention. Like reference numerals refer to like elements throughout the specification.

Thicknesses are enlarged in order to clearly express various layers and regions in the drawings. Throughout the specification, like reference numerals are assigned to similar parts. When a part, such as a layer, film, region, plate, etc., is referred to being “on” another part, it may be directly on another part or intervening parts may be also present. In contrast, when a part is referred to being “directly on” another part, it means that intervening parts are not present. In addition, when a part, such as a layer, film, region, plate, etc., is referred to being “below” another part, it may be “directly below” another part or intervening parts may be also present. In contrast, when a part is referred to being “directly below” another part, it means that intervening parts are not present.

Spatially relative terms “below,” “beneath,” “lower,” “above,” “upper,” etc., may be used to easily describe a correlation between an element or components and another element or components as shown in the drawings. Spatially relative terms should be understood as terms including different directions of an element during use or operation in addition to the orientation shown in the drawings. For example, when an element shown in the drawings is turned over, an element described as being “below” or “beneath” another element may be placed “above” another element. Accordingly, an exemplary term “below” may include both directions below and above. The element may be also oriented in other directions, and thus spatially relative terms may be interpreted according to orientation.

In the present specification, when a part is referred to being connected to another part, the part may be directly connected or intervening elements may be present. In addition, when a part is referred to include a certain component, it means that the part may further include other components rather than excluding the other components, unless otherwise particularly specified.

In the present specification, terms such as first, second, third, etc. may be used to describe various components, but these components are not limited to the terms. The terms may be used only for distinguishing one component from other components. For example, a first component may be referred to as a second or third component without departing from the scope of the present invention, and similarly, the second or third component may be also referred alternatively.

All terms (including technical and scientific terms) used herein may be used with the meaning commonly understood by those skilled in the art to which the present invention pertains, unless otherwise defined. In addition, terms defined in a commonly used dictionary are not to be interpreted ideally or excessively unless clearly defined in particular.

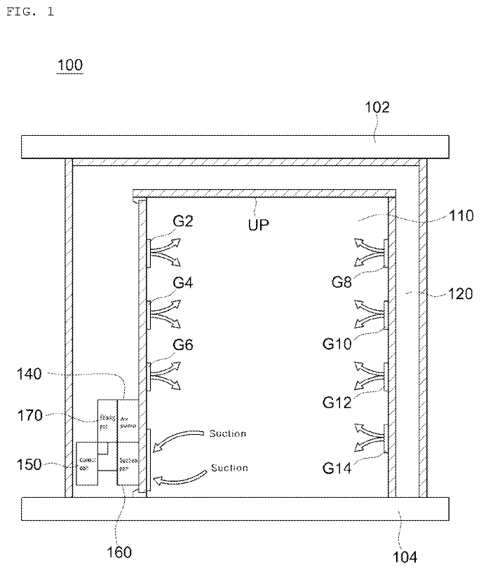

Hereinafter, a hybrid clean room system and a manufacturing method therefor according to the present invention will be described with reference to FIGS. 1 to 9.

FIG. 1 is a sectional view schematically showing an overall configuration of a hybrid clean room system according to an embodiment of the present invention.

Referring to FIG. 1, a hybrid clean room system 100 according to an embodiment of the present invention may include a clean room 110, a circulation part 120, an air pump 140, a plurality of air outlets G1 to G14, a control part 150, a suction part 160, and a filtering part 170.

The clean room 110 may refer to a room which maintains a clean space by removing fine dust particles, bacteria, odors, or the like indoors by using a flow of air, and is mainly disposed on a door or an entrance and exit in a building or structure.

The clean room 110 may include: a plurality of side walls W1 to W4 arranged in the vertical direction between a floor part 102 and a ceiling part 104, which face each other; an upper plate UP positioned on the plurality of sidewalls W1 to W4; and doors 210 and 220 arranged on two facing side walls W1 and W3 from among the plurality of side walls.

The clean room 110 may be a space formed to be sealed on four sides through a wall structure between the floor part 102 and the ceiling part 104. In other words, the clean room 110 may be formed to be sealed in such a way that the first side wall W1 to the fourth side wall W4 extend in the vertical direction from a ceiling surface of the ceiling part 102 and a floor surface of the floor part 104. In this case, the clean room 110 formed by extending the first to fourth side walls W1 to W4, respectively, in a direction perpendicular to the ceiling surface and the floor surface may have, for example, a cube or cuboid shape. The ceiling surface and the wall structure may be, for example, an anti-static 50T clean panel (SCP), but is not limited thereto, and wall structures of other materials may be also used. The floor surface used herein may include anti-static tiles or sheets.

The circulation part 120 may be disposed outside of the clean room 110 and form a closed space along the upper plate UP with other two facing side walls W2 and W4 from among the plurality of side walls. In other words, the circulation part 120 may have a closed space formed along the two facing side walls W2 and W4 and the upper plate UP of the ceiling part 102 and communicate with the clean room 110 through the plurality of air outlets G1 to G14. In other words, the circulation part 120 may be formed as a closed space along the second side wall W2, the upper plate UP, and the fourth side wall W4, which form the clean room 110 having, for example, a cube or cuboid shape.

The air pump 140 may be disposed in the circulation part 120 to discharge air. In other words, the air pump 140 may discharge air into the circulation part 120 by a rotational force of a motor.

The plurality of air outlets G1 to G14 may be arranged on other two facing side walls W2 and W4 from among the plurality of side walls to supply the clean room 110 with the air discharged from the air pump 140 and passing through the circulation part 120.

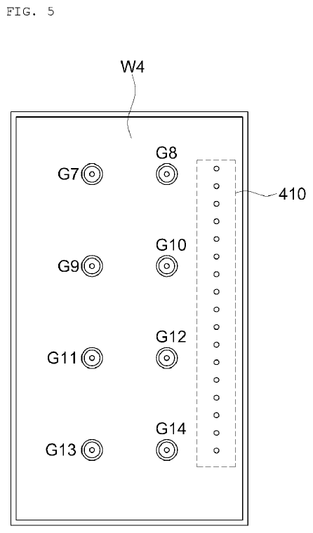

As shown in FIG. 5, the hybrid clean room system 100 according to the present invention may further include a first sensor part 410 disposed in the clean room 110 so as to detect a visitor and a body size thereof in the clean room 110. FIG. 5 is a view showing one example of a first sensor part 410 disposed in a clean room according to an embodiment of the present invention. As shown in FIG. 5, in the first sensor part 410, a plurality of sensors may be arranged at a certain interval on any one side wall W4 from among the two side walls W2 and W4, on which a plurality of air outlets are arranged. The plurality of sensors may include an infrared sensor, an ultrasonic sensor or the like. In addition, as another example, the first sensor part 410 may be installed at a door frame of an entrance door 510 as shown in FIG. 5, so as to detect an incoming visitor.

The control part 150 may control an operation of the air pump 140 and the suction part 160 based on the sensing information of the first sensor part 410. In other words, when detecting a visitor in the clean room 110 through the first sensor part 410, the control part 150 may operate the air pump 140 to control the air to be discharged, and may control an operation of the suction part 160 so that the air in the clean room 110 may be sucked in.

Then, when detecting a body size (height) of a visitor inside of the clean room 110 through the first sensor part 410, the control part 150 may open the air outlets positioned below a shoulder height of the visitor and have clean air supplied from the circulation part 120 to the clean room 110 through the open air outlets.

Although not shown in the drawings, the hybrid clean room system 100 according to the present invention may further include an opening/closing adjustment part for adjusting opening and closing of the plurality of air outlets G1 to G14 on a rear surface of the two side walls W2 and W4, on which the plurality of air outlets G1 to G 14 are arranged.

Thus, the control part 150 may open and close the plurality of air outlets G1 to G14 through the opening/closing adjustment part according to a body size (height) of a visitor detected through the first sensor part 410.

The suction part 160 may be disposed on at least one of the plurality of side walls and connected to the air pump 140 so as to suction the air of the clean room 110. In other words, the suction part 160 may suck the air containing dust or pollutants separated from the visitor by the air sprayed into the clean room 110.

The filtering part 170 may be disposed at the air outlet of the air pump 140, so as to filter out dust and pollutants, fight bacteria and sterilize the air sucked through the suction part 160. Specifically, the filtering part 170 may include a filter for filtering out pollutants including fine dust, an antibacterial filter for preventing the growth mold and bacteria, and a deodorizing filter for removing odors. The filter for filtering out dust and pollutants used in the present invention may include a HEPA filter with a H13 grade, and the antibacterial filter used herein may include a filter having a nonwoven fabric coated with nanoparticles such as silver, copper, gold or the like having antibacterial properties. And, the deodorizing filter used herein may include a filter made of activated carbon, charcoal, etc.

In addition, the filtering part 170 may include metal nanoparticles having a function of fighting bacteria, sterilizing the filtered air, emitting far-infrared rays to the filtered air, or emitting minerals. Metal nanoparticles may be at least one selected from the group consisting of silicon (Si), copper (Cu), zinc (Zn), brass, aluminum (Al), beryllium (Be), magnesium (Mg), germanium (Ge), strontium (Sr), barium (Ba), yttrium (Y), titanium (Ti), zirconium (Zr), hafnium (Hf), vanadium (V), niobium (Nb), tantalum (Ta), lanthanum (La), silver (Ag), gold (Au), platinum (Pt), palladium (Pd), and oxides thereof. As another example, the filtering part 170 may be installed between the suction part 160 and the air pump 140.

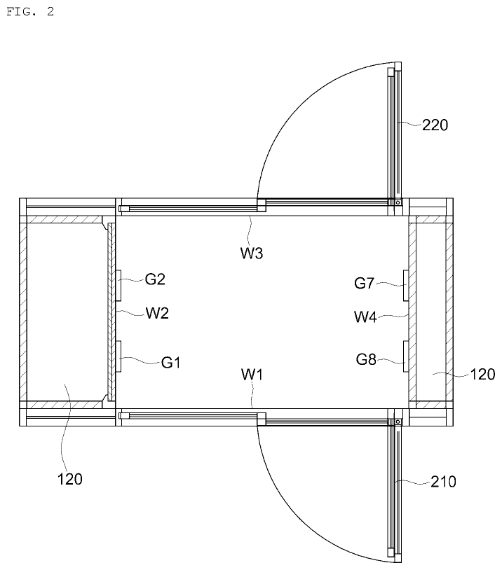

Meanwhile, as shown in FIGS. 2 to 4, in the clean room 110, doors 210 and 220 may be arranged on the two facing side walls W1 and W3 from among the first to fourth side walls W1 to W4, and the plurality of air outlets G1 to G14 may be arranged on the other two facing side walls W2 and W4. FIG. 2 is a view showing an example in which a plurality of air outlets G1 to G14 and doors 210 and 220 are arranged at a wall of a clean room according to an embodiment of the present invention. As shown in FIG. 2, the clean room 110 may be made of a panel wall structure in which the first side wall W1 to the fourth side wall W4 are orthogonal to each other, and an entrance door 210 may be disposed on the first side wall W1, which a visitor faces when entering the room, and an exit door 220 may be disposed on the third side wall W3 facing the first side wall W1. Of course, the entrance door 210 and the exit door 220 may be disposed opposite to each other. In other words, the exit door 220 may be disposed at the first side wall W1 of the clean room 110, and the entrance door 210 may be disposed at the third side wall W3 facing the first side wall W1.

The plurality of air outlets G1 to G14 may be arranged at a certain interval at two facing side walls W2 and W4 of the clean room 110, respectively, so as to communicate the clean room 110 and the circulation part 120 with each other. Thus, the air discharged from the air pump 140 to the circulation part 120 may be supplied from the circulation part 120 to the clean room 110 through the plurality of air outlets G1 to G14.

In the clean room 110, the first side wall W1 may be composed of a panel wall structure and the entrance door 210, and a height of the panel wall structure and the entrance door 210 may be equal to or less than a height from the floor surface to the upper plate UP.

In the clean room 110, the third side wall W3 facing the first side wall W1 may be formed to have the same structure as that of the first side wall W1, that is, to have the panel wall structure and the exit door 220, and a height of the panel wall structure and the exit door 220 may be equal to or less than a height from the floor surface to the upper plate UP.

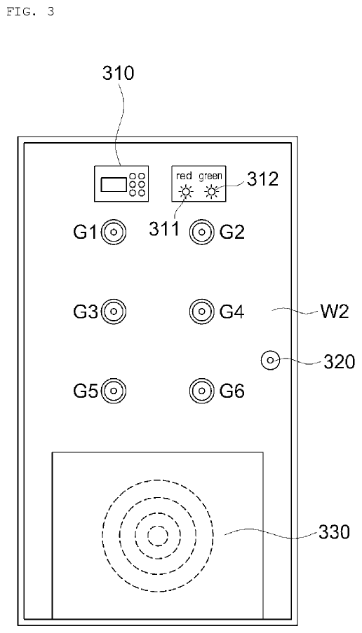

In the clean room 110, the second side wall W2 may have a plurality of air outlets parts G1 to G6 arranged at an upper side so that the air discharged from the air pump 140 may be discharged from the circulation part 120 to the clean room 110 as shown in FIG. 3. FIG. 3 is a view showing a second wall W2 of a clean room according to an embodiment of the present invention. In FIG. 3, at an upper side of the second side wall W2, a shower controller 310 for controlling whether or not air is discharged in the clean room 110, the intensity of the air, and the opening/closing adjustment part may be disposed in the clean room. In other words, the shower controller 310 may adjust an amount or speed of the air shower discharged from the circulation part 120 to the clean room 110 or set whether the air shower is discharged or not.

In addition, the second side wall W2 may be provided with a first light 311 and a second light 312 for indicating a concentration of dust in the clean room. In the present invention, the second side wall W2 or the other side walls W1, W3 and W4 may be provided with a dust measuring sensor (not shown) for measuring a concentration of fine dust or dust contained in the air in the clean room 110. The first light 311 may turn on when the concentration of fine dust or dust measured by the dust measuring sensor is measured to be a preset reference or above, and the second light 312 may turn on when the concentration of dust is less than the preset reference concentration, thereby notifying the visitor. In an embodiment of the present invention, the first light may be a red light and the second light may be a green light.

And, when the concentration of dust measured by the dust measuring sensor is equal to or greater than the reference concentration, the control part 150 may increase a rotational speed of the motor of the air pump 140 so as to increase an amount of air intake and may also increase an amount of air supply to the clean room 110 through the plurality of air outlets G1 to G14, thereby promptly decreasing the concentration of dust in the clean room 110.

In addition, as another embodiment, when the concentration of dust measured by the dust measuring sensor is equal to or greater than the reference concentration, the control part 150 may maintain a locking device (not shown) provided at the exit door 220 to be in a locked state, and when the concentration of dust is equal to or less than the reference concentration, the control part 150 may convert the locking device of the exit door 220 into an open state. Thus, the visitor entering the clean room 110 may check if the concentration of dust falls below the reference and then safely exit through the open exit door 220.

Meanwhile, as another embodiment, the dust measuring sensor may be installed outside of the clean room 110 or outside of a structure in which the clean room 110 is installed, so as to measure the concentration of fine dust or dust outside of the clean room 110. In addition, as such, a third light (not shown), which turns on when the concentration of fine dust or dust measured by the dust measuring sensor is measured to be equal to or higher than a preset reference, and a fourth light (not shown), which turns on when the dust concentration is less than the preset reference concentration, may be installed at one side wall inside the clean room 110.

In addition, an inspection handle 320 for opening the second side wall W2 may be disposed at one side of the second wall W2, in order to inspect or maintain the air pump 140, etc., disposed in the circulation part 120. The second side wall W2 may be rotatably coupled by a hinge to a corner part which is coupled to the first wide wall W1 connected thereto or the first side wall W1, and an inspection may be performed after holding the inspection handle 320 and rotating and opening the second side wall W2 in order to inspect the suction part 160, the filtering part 170, the air pump 140, and the control part 150, which are disposed in the circulation part 120.

In addition, a suction port 330 for sucking air of the clean room 110 may be disposed on a lower side of the second side wall W2. In this case, the suction port 330 may be disposed in a form of having a plurality of holes penetrating the clean room 110 and the circulation part 120.

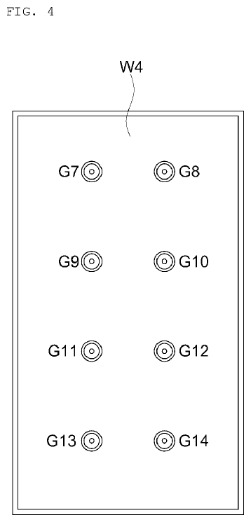

As shown in FIG. 4, a plurality of air outlets G7 to G14 penetrating the clean room 110 and the circulation part 120 may be arranged at a regular interval at the fourth side wall W4 of the clean room 110. FIG. 4 is a view showing a fourth wall surface of a clean room according to an embodiment of the present invention. In FIG. 4, the air outlet G7 to the air outlet G14 may have a plurality of holes penetrating the clean room 110 and the circulation part 120, in which each hole may have various forms such as a circle, ellipse, square or spiral shape, etc.

Meanwhile, in the clean room 110, doors 210 and 220 may be arranged on two facing side walls W1 and W3 from among the first to fourth side walls W1 to W4.

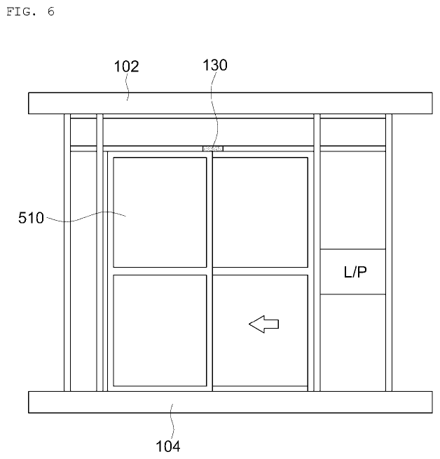

In the clean room 110, the entrance door 210 disposed on the first side wall W1 and the exit door 220 disposed on the third side wall W3 may be each arranged in a form of a hinged door as shown in FIG. 2, or may be arranged in a form of a sliding door as shown in FIG. 6. FIG. 6 is a view showing an entrance door disposed in a clean room according to another embodiment of the present invention.

In FIG. 6, the first side wall W1 may be provided with an opening button, a number key or a recognition part for recognizing a security card of a visitor, so as to open the entrance door 510 at a right side of the entrance door 510, through which the entrance door 510 may be opened.

In addition, as another example, the second sensor part 130 disposed at an upper portion of the entrance door 510 to detect a visitor may be provided. In other words, the second sensor part 130 may be configured to detect an opening/closing operation of the entrance door or a visitor entering the clean room 110. The second sensor part 130 may include an infrared sensor, an ultrasonic sensor or the like. In this case, the entrance door 510 may be made of an automatic door that opens and closes depending on whether a visitor is detected or not by the second sensor part 130, and may be automatically opened in the form of a sliding door when a visitor is detected through the second sensor part 130, and then may be automatically closed after the visitor enters the clean room 110. The control part 150 may perform an operation of opening the entrance door 510 when the visitor entering the clean room 110 is detected through the second sensor part 130, and may perform an operation of closing the entrance door 510 when the visitor is not detected through the second sensor part 130.

And at the same time when the entrance doors 210 and 510 are opened, the air pump 140 may be operated for a certain time (for example, up to 90 seconds) by the control part 150, and then air may be supplied into the clean room 110 through the air outlets G1 to G14. An operating time of the air pump 140 may be adjusted, and a remaining time after the start of the operation may be displayed on the shower controller 310. When the operating time is over, the operation of the air pump 140 may be stopped and the visitor may go out by pressing an opening button (not shown) formed at a right side of the exit door 220. In addition, the exit door 220 may be automatically opened after the operation is terminated by the control part 150.

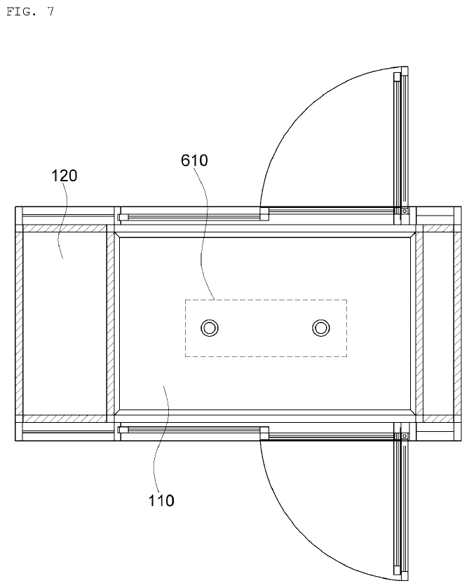

Meanwhile, the hybrid clean room system 100 according to the present invention may further include a lighting part 610 for providing lighting to the clean room, as shown in FIG. 7. FIG. 7 is a view showing a lighting part 610 providing lighting to a clean room according to an embodiment of the present invention. As shown in FIG. 7, the lighting part 610 may include at least one or more lights (light 1 and light 2) on the ceiling part 102 of the clean room 110, and may turn ON and OFF each light according to a detected number of visitors, thereby adjusting the brightness of the clean room 110. Thus, in case of the clean room 110, a bright environment may be automatically provided to the clean room by lights corresponding to a number of visitors from the lighting part 610.

Although not shown in the drawings, when detecting the number of visitors entering the inside of the clean room 110 through the second sensor part 130 or the first sensor part 410, the control part 150 may control an amount of discharge from the air pump 140 and an opening/closing operation of the plurality of air outlets G1 to G14 so that air may be supplied to the clean room 110 by the amount of discharge of the air shower, corresponding to the number of visitors.

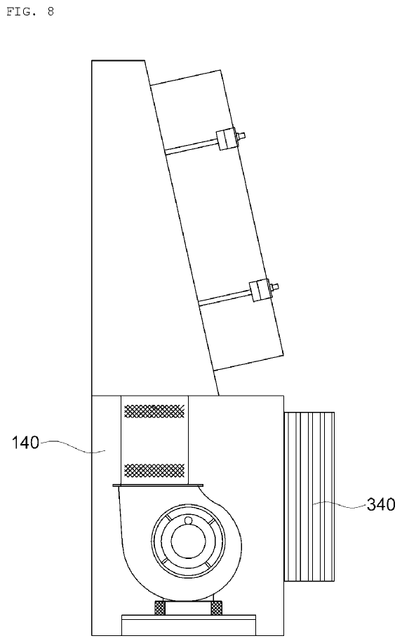

FIG. 8 is a view showing an air pump for discharging air to a clean room according to an embodiment of the present invention.

Referring to FIG. 8, the air pump 140 according to an embodiment of the present invention may include a communication part 340 connected to the suction port 330 of the suction part 160 and a motor (not shown) providing a rotational force.

Although not shown in FIG. 8, the air pump 140 may further include a connection part or an interface part for receiving a control command from a motor driving part and the control part 150 for controlling a rotational operation of the motor.

The air pump 140 may increase or decrease a rotation speed of the motor according to the control command of the control part 150, and accordingly adjust an amount of air intake, an amount and speed of discharge of the air discharged to the clean room 110.

Meanwhile, the hybrid clean room system 100 according to the present invention may further include an opening/closing adjustment part for adjusting opening and closing of the plurality of air outlets G1 to G14, though not shown in the drawings. The opening/closing adjustment part may be installed on a rear surface of the two side walls W2 and W4, on which the plurality of air outlets G1 to G14 are arranged, to be mechanically interlocked with the plurality of air outlets G1 to G14.

Thus, the control part 150 may open and close the plurality of air outlets G1 to G14 through the opening/closing adjustment part according to a body size (height) of a visitor detected through the first sensor part 410.

For example, the control part 150 may control the air to be sprayed below a shoulder height of a visitor positioned in the clean room 110 by opening air outlets positioned below a shoulder height (20 to 30 cm) rather than a height of the visitor detected through the first sensor part 410 from among the plurality of air outlets arranged, respectively, at a certain interval at the second side wall W2 and the fourth side wall W4 of the clean room 110. In this case, the opening and closing of the air outlets positioned 20 to 30 cm below the height of the visitor is to control the air outlets 20 to 30 cm below the height of the visitor, as it is generally within about 20 to 30 cm from a tip of a person's head to the shoulder. However, the present invention is not limited thereto, and may also be implemented by opening and closing the air outlets 30 to 40 cm below the height of the visitor.

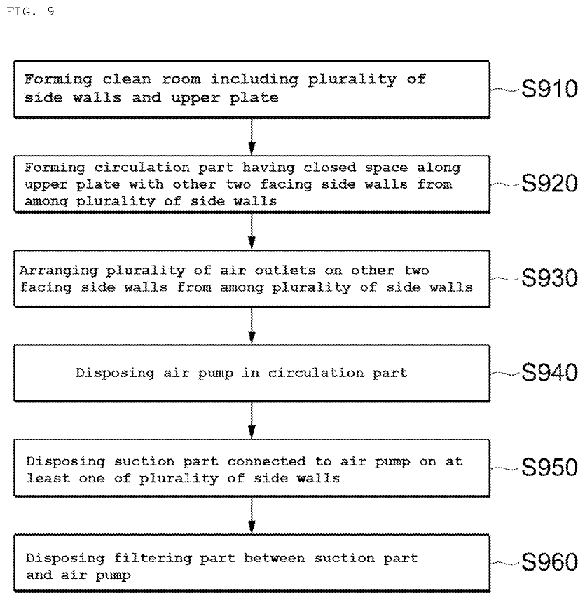

FIG. 9 is a view showing a flow chart of operations for explaining a method for manufacturing a hybrid clean room according to an embodiment of the present invention.

Referring to FIG. 9, in the hybrid clean room system 100 according to an embodiment of the present invention, the clean room 110 including a plurality of side walls W1 to W4 and an upper plate UP may be first formed (S910)

In other words, as shown in FIGS. 1 to 4, the clean room 110 may include a plurality of side walls W1 to W4 arranged in the vertical direction between a floor part 104 and a ceiling part 102, which face each other, and an upper plate UP positioned on the plurality of side walls, and may also include doors 210 and 220 arranged on two facing side walls W1 and W3 from among the plurality of side walls.

In this case, a first sensor part 410 for detecting a visitor and a body size thereof in the clean room 110 may be disposed in the clean room 110. For example, in the first sensor part 410, a plurality of sensors having a regular interval may be arranged on the fourth side wall W4, on which the plurality of air outlets G7 to G14 are arranged, as shown in FIG. 5.

Then, the circulation part 120 having a closed space along the upper plate UP with other two facing side walls W2 and W4 from among the plurality of side walls may be formed outside of the clean room 110.

In this case, the control part 120 for controlling an operation of the air pump 140 and the suction part 160 based on the sensing information of the first sensor part 410 may be disposed in the circulation part 120.

Then, the plurality of air outlets G1 to G14 may be arranged on other two facing side walls W2 and W4 from among the plurality of side walls W1 to W4 (S930).

In this case, an opening/closing adjustment part for adjusting opening and closing of the plurality of air outlets G1 to G14 may be arranged on at least one of the plurality of side walls W1 to W4. Of course, the opening/closing adjustment part may be disposed at a rear surface of at least one of the plurality of side walls W1 to W4.

Then, the air pump 140 may be disposed in the circulation part 120 (S940).

In this case, the air pump 140 may be disposed so that the air outlet faces the circulation part 120.

Then, the suction part 160 connected to the air pump 140 may be disposed on at least one of the plurality of side walls W2 and W4 (S950).

In other words, the suction part 160 may be disposed at the second side wall W2 on which the suction port 330 is disposed as shown in FIG. 3, to be connected to the air pump 140 in accordance with the suction port 330. Accordingly, the air sucked through the suction part 160 may be discharged to the circulation part 120 through the air pump 140.

In this case, the suction part 160 may suck the air containing dust or pollutants separated in the clean room 110 from the visitor from the clean room 110.

Then, the filtering part 170 may be disposed between the suction part 160 and the air pump 140 (S960).

Accordingly, the air containing dust or pollutants sucked through the suction part 160 may be filtered through the filtering part 170, thereby discharging clean air to the circulation part 110 through the air pump 140.

In addition, the filtering part 170 may fight bacteria and sterilize the filtered air through metal nanoparticles, emit far-infrared rays to the filtered air, or emit minerals. In this case, metal nanoparticles may be at least one selected from the group consisting of silicon (Si), copper (Cu), zinc (Zn), brass, aluminum (Al), beryllium (Be), magnesium (Mg), germanium (Ge), strontium (Sr), barium (Ba), yttrium (Y), titanium (Ti), zirconium (Zr), hafnium (Hf), vanadium (V), niobium (Nb), tantalum (Ta), lanthanum (La), silver (Ag), gold (Au), platinum (Pt), palladium (Pd), and oxides thereof.

The control part 150 may open and close the plurality of air outlets G1 to G14 through the opening/closing adjustment part according to a body size of a visitor detected through the first sensor part 410. [99] In other words, when the first sensor part 410 detects a height of a visitor positioned in the clean room 110, the control part 150 may open air outlets positioned 20 to 30 cm below a height of the visitor from among the plurality of air outlets G1 to G4 through the opening/closing adjustment part, so that clean air may be supplied from the circulation part 120 to the clean room 110 through the opened air outlets.

Accordingly, in the clean room 110, fine dust or pollutants attached to the clothes, hair or the like of the visitor entering the room may be removed by the clean air.

And, in the clean room 110, a shower controller 310 for controlling whether or not air is discharged in the clean room, the intensity of the air, and the opening/closing adjustment part may be disposed at the second side wall W2 as shown in FIG. 3.

Thus, when the air discharged through the plurality of air outlets G1 to G14 in the clean room 110 is equal to a height of the body or an amount of discharge is equal to or greater than a certain amount, the visitor positioned in the clean room 110 may manipulate the shower controller 310, so that the air outlets at the body height may not be operated, or the amount of discharge may be adjusted to be equal to or less than a certain amount.

In the clean room 110 according to an embodiment of the present invention, a wall structure may be set flexibly according to a height of an entrance, and may be, for example, a panel wall structure with a width of 1200 mm and a height of 2500 mm. In this case, the wall structure used herein may include a lightweight wall structure which uses aluminum honeycomb as a core material within a surface of steel or aluminum material which has a thickness of 50 mm and has both sides subjected to an anti-static treatment with a value of 10⁶ to 10⁸Ω, and uses an aluminum bar for a four-sided edge.

In the clean room 110 according to an embodiment of the present invention, the ceiling part 102 used herein may include a lightweight ceiling of the industrial clean room, which uses aluminum honeycomb as a core material within a surface of steel or aluminum material which has a length of 1200 mm, a width of 2300 and a thickness of 50 mm and has both sides subjected to an anti-static treatment with a value of 10⁶ to 10⁸Ω, and uses an aluminum bar for a four-sided edge.

In the clean room 110 according to an embodiment of the present invention, doors 210 and 220 may be set flexibly according to a height of an entrance, and may be manufactured as a lightweight door which uses aluminum honeycomb as a core material within a surface of steel or aluminum material which has a width of 1200 mm, a height of 2200 and a thickness of 40 mm and has both sides subjected to an anti-static treatment with a value of 10⁶ to 10⁸Ω, and uses an aluminum bar for a four-sided edge, or an electric automatic door which uses an aluminum bar on four sides as a frame and 5 mm reinforced anti-static acrylic on one side in the frame.

The hybrid clean room system 100 according to an embodiment of the present invention may have the circulation part 120, the air pump 140, the suction part 160, and the filtering part 170 embedded in the upper ceiling and left and right wall structures W2 and W4. With regard to the air shower discharged to the clean room 110, the hybrid clean room system may be equipped with a shower controller 310 in a form of a selectable button so that only an upper air shower may be operated, or only left and right air showers may be operated, and the upper and left and right air showers may be operated at the same time, thereby improving user convenience.

Accordingly, the clean room 110 may effectively remove fine dust adhering to the front and back of the clothes of the visitor, fine dust adhering to the hair, or the like.

In addition, while the visitor is receiving an air shower, the filtering part 170 may supply clean air to the clean room 110 through a filter to which a HEPA filter with a H13 grade used in a high-end air purifier is applied.

In addition, the suction part 160 embedded in the left and right wall structures may suck fine dust, etc., which has fallen in the clean room 110 through a vacuum pump while the visitor is receiving an air shower in the clean room 110, thereby sending the fine dust, etc., to a dust collector connected to an air conditioning system in a residential space.

According to the present invention as described above, it is possible to realize the hybrid clean room system and a manufacturing method therefor, which allows a clean room to be manufactured on entrances and exits in the private sector such as residence, business, education, leisure, etc., and is capable of separating and collecting dust, pollutants, fine dust or the like from a visitor through an air shower when the visitor enters the clean room, and filtering and circulating the air in the clean room.

The present invention described above is not limited to the above-described embodiments and the accompanying drawings, and it is apparent to those skilled in the art to which the present invention pertains that various substitutions, modifications and changes are possible within the scope without departing from the technical spirit of the present invention.

1. A hybrid clean room system comprising:
a clean room which includes a plurality of side walls arranged in a vertical direction between a floor part and a ceiling part, which face each other, and an upper plate positioned on the plurality of side walls, and which includes doors arranged on two facing side walls from among the plurality of side walls;
a circulation part which is disposed outside of the clean room, and which forms a closed space along the upper plate with other two facing side walls from among the plurality of side walls;
an air pump disposed in the circulation part so as to discharge air;
a plurality of air outlets, which are arranged on the other two facing side walls from among the plurality of side walls so as to supply, to the clean room, the air that is discharged from the air pump and passes through the circulation part;
a suction part disposed on at least one of the plurality of side walls, and connected to the air pump so as to suction the air from the clean room; and
a filtering part disposed in the air pump so as to filter out dust or pollutants from the air suctioned through the suction part,
wherein a wall structure forming the side wall and the ceiling part in the clean room include a metal panel which is subjected to an anti-static treatment with a value of 10⁶ to 10⁸Ω.

2. The hybrid clean room system of claim 1, further comprising:
a lighting part providing lighting to the clean room.

3. The hybrid clean room system of claim 1, wherein the filtering part comprises a filter for fighting bacteria in the air.

4. The hybrid clean room system of claim 1, wherein the side wall at which the suction part is disposed is rotatably coupled by a hinge to a corner part which is coupled to an adjacent side wall, and
an inspection handle is provided for opening the side wall at which the suction part is disposed.
